(19) United States
(12) Patent Application Publication
(10) Pub. No.: US 2025/0224050 A1
(43) Pub. Date: Jul. 10, 2025

(54) RETAINER FOR HOLDING CORDS, CABLES AND OTHER ITEMS

(71) Applicants: Matthew Robinson, Mount Airy, MD (US); Glen Harrison, Pylesville, MD (US)

(72) Inventors: Matthew Robinson, Mount Airy, MD (US); Glen Harrison, Pylesville, MD (US)

(21) Appl. No.: 19/010,712

(22) Filed: Jan. 6, 2025

Related U.S. Application Data
(60) Provisional application No. 63/617,548, filed on Jan. 4, 2024.

(51) Int. Cl. F16L 3/12; F16B 45/00

(52) U.S. Cl. CPC F16L 3/1218; F16B 45/005; F16B 2200/83

(57) ABSTRACT

A retainer for retaining elongated objects against magnetizable portions of other objects. The retainer provides a body portion extending between a first and second end and a recess along an outer surface of the body portion that defines two opposing coplanar attachment areas, wherein each attachment area has a magnetic attraction to magnetizable material; and an eye hook extending from the second end. Additionally, a carabiner operatively associated with the eye hook to enable greater functionality of the retainer.

### CROSS REFERENCE TO RELATED APPLICATION

This application claims the benefit of priority of U.S. provisional application No. 63/617,548, filed Jan. 4, 2024, the contents of which are herein incorporated by reference.

### BACKGROUND OF THE SUBJECT DISCLOSURE

The present subject disclosure relates to retainers for holding cords, cables and other items and, more particularly, to a magnetic block with an arch recess and eye hook to hold cords, cables and other items to magnetizable objects.

Cords and cables are a hassle to store, often taking up shelving space that could be used for other tools. Also, when those cords or cables are associated with heavy appliances, they can get under foot or get caught on another object when moving the associated appliance.

Current comparative products use thin plastic and adhesive to hold cords or cables, but they can only be used once and tend to be limited in application; for instance, being specifically made for residential sized cords only, and thus not usable for commercial cords or cables.

As can be seen, there is a need for a magnetic block with an arch recess and eye hook to hold cords, cables and other items to magnetizable objects.

### SUMMARY OF THE SUBJECT DISCLOSURE

The subject disclosure contemplates a cord retainer using commercial grade thick plastic and magnetizable material for the body portion for innumerable repetitive uses involving the body portion of the retainer pinning the cord against the magnetizable object

The subject disclosure easily holds cords and cables to the side of any magnetizable object, including storage units, shelving, even the fasteners that mount the shelving, or the like, to obviate the need for shelving space. Also, when moving or storing appliances, the subject disclosure easily, removably, and securely holds the cords or cables to its associated appliance, thereby preventing the cords or cables from falling and being damaged as well as preventing a tripping hazard.

The subject disclosure includes an eye hook, whereby other objects can be removably retained or temporarily secured by the eye hook or by a carabiner that operatively associates with the eye hook, thereby maximizing the utility while adding versatility to our product.

In one aspect of the subject disclosure, a retainer for retaining elongated objects against magnetizable portions of other objects, the retainer providing the following: a body portion extending between a first and second end; a recess along an outer surface of the body portion that defines two opposing coplanar attachment areas; each attachment area having a magnetic attraction to magnetizable material; and an eye hook extending from the second end.

In another aspect of the subject disclosure, the retainer further provides a carabiner operatively associated with the eye hook, wherein the recess is an arch shape, wherein the body portion is a rectangular prism, and wherein the recess is disposed in one of the four sidewalls of the rectangular prism.

In yet another aspect of the subject disclosure, a method of securing a cord of an appliance, the method provides enclosing a portion of the cord within the recess of the foregoing retainer while the two opposing coplanar attachment areas magnetically engage a magnetizable material of the appliance.

In still yet another aspect of the subject disclosure, a method of securing a cord as it passes from a first room to a second room, the method comprising: enclosing a portion of the cord within the recess of the retainer of the foregoing retainer while the two opposing coplanar attachment areas magnetically engage a magnetizable material of a doorway interconnecting the first and second rooms.

These and other features, aspects and advantages of the present subject disclosure will become better understood with reference to the following drawings, description and claims.

### BRIEF DESCRIPTION OF THE DRAWINGS

FIG. 1 is a perspective view of an exemplary disadvantage of the prior art, whereby moving an appliance without securing the appliance's power cord can be problematic.

FIG. 2 is a perspective view of an exemplary disadvantage of the prior art, illustrating the damage that can occur through use of other solutions to the problem of securing cords when moving the associated appliance.

FIG. 3A is a perspective view of an exemplary embodiment of the subject disclosure.

FIG. 3B is a perspective view of an exemplary embodiment of the subject disclosure.

FIG. 4 is a perspective view of an exemplary embodiment of the subject disclosure, shown in use pinning a cord 60 against a magnetizable object 50.

FIG. 5 is a perspective view of an exemplary embodiment of the subject disclosure, shown in a storage condition.

FIG. 6 is a perspective view of an exemplary embodiment of the subject disclosure, illustrating how an entire cord 60 can be retained, hung from, and stored by pinning the neck of the cord 60, just below its head, against an magnetizable object 50 (which could be a door frame), whereby the remainder of the cord 60 can be wound up and hung from said neck (or, alternatively, the eye hook 20 and/or carabiner 40), thereby obviating the need for shelving for the cord.

FIG. 7 is a perspective view of an exemplary embodiment of the subject disclosure, illustrating how the embodied retainer can facilitate a selected path that a cord 60 takes as it is retained out of the way, say as it passes from one room to another room by way of a doorway.

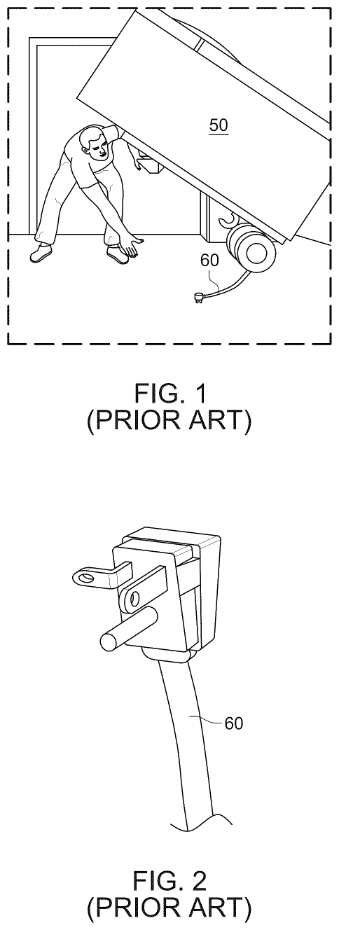

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

Broadly, an embodiment of the subject disclosure provides a magnetic block with an arch recess and eye hook to hold cords, cables and other items to magnetizable objects.

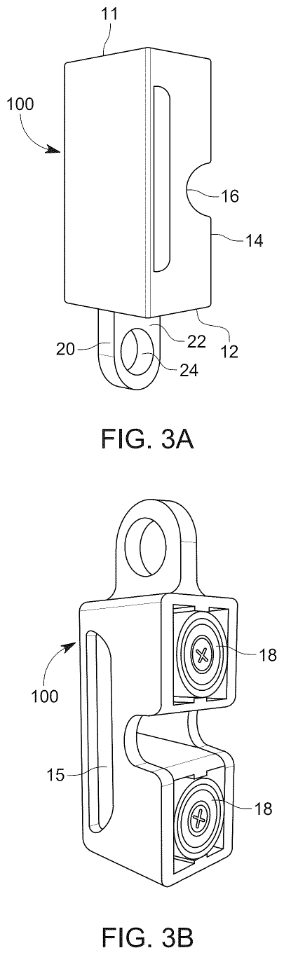

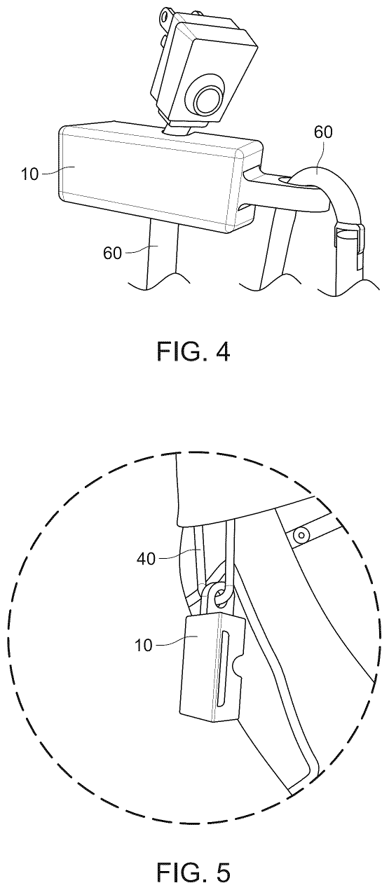

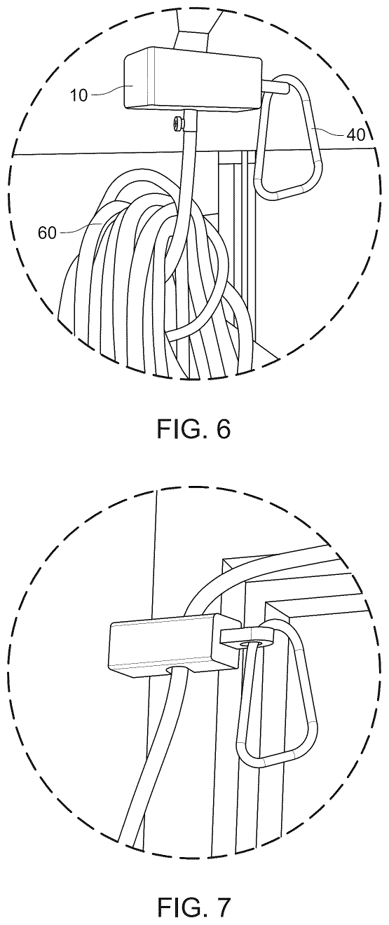

Referring the FIGS. 3A-7, the subject disclosure includes retainer 100 having a body portion 10. The body portion 10 has a first end 11 and the second end 12 and one or more sidewalls 14 extending between the first and second ends 11 and 12. One of the sidewalls 14 has a recess 16 disposed therein. The recess 16 provides a void sufficient to receive one or more standard or commercial electrical cords 40 therein. Typically, the recess will be an arch, arcuate, or U-shaped but need not be if it functions as disclosed herein. Along the sidewall 14 that provides the recess 16, on opposing sides thereof, may be magnets 30 or at least magnetized attachment areas 18. The magnets 30 may be N42 or N52 rare earth magnets or other magnetized material sufficient to support the weight of a roll or spool of cabling. In some embodiments, the entire body portion 10 may be the magnetized material. In FIG. 3B, the magnetized attachment areas 18 are shown to be ‘open’ faces of the body portion 10 at which operative surfaces of magnets are disposed. Though, again, the entire body portion 10 or at least the portions thereof associated with the attachment areas 18 are magnetized without having separate magnets 30. The attachment areas 18, in any case, are co-planar to facilitate an even attachment to a magnetizable object 50.

The body portion 10 may have to opposing grooves 15 on the two sidewall (portions) that bookend the arched recess 16, thereby providing a gripping surface of a user.

An eye hook 20 may extend orthogonally from the second end 12, the eye hook being a tab 22 with an eye hole 24. The eye hole 24 may be dimensioned and sized to receive a carabiner 40.

The body portion 10 can be used to pin a cord 60 within the arch recess 16 (since the sidewall 14 providing the arch recess 16 has two coplanar attachment areas 18, where in some embodiments, the magnets 30 are outward facing) that engage a magnetizable object 50 (such as an object having ferrous metal), thereby confining the cord 60 within the arch recess 16.

The body portion 10, in part, be made from high-density polyethylene (HDPE) commercial grade plastic or other high-density plasticized material. The HDPE commercial grade plastic block (body portion 10) allows for the subject disclosure to be strong enough to be used in a commercial capacity. The magnetized material or magnet 30 allows for the subject disclosure to be used repeatedly on ferrous metal objects (which is ‘magnetizable upon interfacing with the magnetized material 30), such as (but not limited to) shelving units, cabinets, vehicles, and appliances. The attached carabiner 40 allows for larger cords, cables and other items 60 to be attached, thereby maximizing the versatility of the subject disclosure. The carabiner 40 also allows for easy storage of the product. Such as clipping it to one's belt (see FIG. 5) or belongings for easy access when needed.

The subject disclosure may be made by forming a mold that can then be used to pour the plastic into. This forms the main body portion 10 of the subject disclosure. Alternatively, additive manufacture can be used. Two magnets 30 may then be attached to the unit using screws, adhesive, or combination thereof. These magnets can be of any strength or size and are located on the outside or inside cavity of the main body portion 10 of the subject disclosure. The eye hook 20 may be built into the main body portion 10, allowing for a carabiner 40 or similar items to be clipped on or attached to the subject disclosure. The arch recess 16 in the middle of the main body portion 10 can be increased or decreased for various sizes of chords or cables. The eye hook 20 and carabiner 40 significantly increase the versatility of the subject disclosure.

A method of using the retainer 100 may include the following. When moving appliances 50, the mover would simply have to pick up its power cord 60 and place the arch recess 16 over a portion of said cord 60, thereby pinning it against the appliance 50, preventing the cord 60 from dropping and getting damaged or becoming a trip hazard when moving.

Additionally, strong magnetized material allows for the retainer 100 to become quite versatile. The retainer 100 can be used to hold doors open by attaching to the metal door frame, find studs by easily locating screws in the wall, as a keychain to hang keys on any metal door or surface or even clean up metal shavings in seconds.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. A retainer for retaining elongated objects against magnetizable portions of other objects, the retainer comprising:
a body portion extending between a first and second end;
a recess along an outer surface of the body portion that defines two opposing coplanar attachment areas;
each attachment area having a magnetic attraction to magnetizable material; and
an eye hook extending from the second end.

2. The retainer of claim 1, further comprising a carabiner operatively associated with the eye hook.

3. The retainer of claim 1, wherein the recess is an arch shape.

4. The retainer of claim 3, wherein the body portion is a rectangular prism, and wherein the recess is disposed in one of the four sidewalls of the rectangular prism.

5. The retainer of claim 3, wherein the magnetic attraction is provided by a rare earth magnet.

6. A method of securing a cord of an appliance, the method comprising:
enclosing a portion of the cord within the recess of the retainer of claim 1 while the two opposing coplanar attachment areas magnetically engage a magnetizable material of the appliance.

7. A method of securing a cord as it passes from a first room to a second room, the method comprising:
enclosing a portion of the cord within the recess of the retainer of claim 1 while the two opposing coplanar attachment areas magnetically engage a magnetizable material of a doorway interconnecting the first and second rooms.
